(19) United States
(12) Patent Application Publication
(10) Pub. No.: US 2017/0136584 A1
(43) Pub. Date: May 18, 2017

(54) Aluminum Welding Filler Metal

(71) Applicant: Illinois Tool Works, Glenview, IL (US)

(72) Inventors: Patrick Berube, Traverse City, MI (US); Bruce E. Anderson, Traverse City, MI (US); Stephen L. Anderson, Traverse City, MI (US)

(21) Appl. No.: 15/348,655

(22) Filed: Nov. 10, 2016

Related U.S. Application Data
(60) Provisional application No. 62/254,814, filed on Nov. 13, 2015.

(51) Int. Cl. B23K 35/28; B21C 23/00; C22C 21/02; F16B 5/08; B23K 31/02; C22C 21/08

(52) U.S. Cl. CPC B23K 35/286; B23K 31/02; C22C 21/08; C22C 21/02; F16B 5/08; B21C 23/002

(57) ABSTRACT

A 5xxx or 6xxx series aluminum welding filler metal alloy for welding 3xxx, 5xxx, 6xxx, and 7xxx series alloys. This alloy is designed to use the high solidification rate from liquid to solid metal that is present in the welding process to achieve its superior mechanical properties. The alloy uses dispersion strengthening with Mg₂Si dispersoids and precipitation strengthening with Mg₂Si precipitates as well as solid-solution strengthening using free magnesium and manganese. The alloy has high as-welded mechanical properties and excellent corrosion resistance. The alloy is positively affected by post-weld thermal treatments and whether used as welded or post-weld thermally treated, provides mechanical properties in excess of the base metals being joined. Alloy compositions are available for use at elevated temperature service up to 250 degrees F. This 6xxx series filler metal is particularly suited for producing both statically and dynamically loaded high strength welded structures for automobiles, truck trailers, rail cars, ships, aerospace, and other applications.

### CROSS REFERENCE TO RELATED APPLICATIONS

This application claims priority to U.S. Provisional Patent Application No. 62/254,814, filed on Nov. 13, 2015, which is hereby incorporated by reference in its entirety.

### BACKGROUND OF THE INVENTION

This invention relates to the field of welding high strength aluminum structures, and more particularly to filler metal alloy compositions suitable for the welding process and having superior weldment physical and mechanical properties.

Welding is, at its core, simply a way of bonding two pieces of metal. There are many types of welding processes used to join metal components. Some of these include Gas Metal Arc Welding (GMAW), Gas Tungsten Arc Welding (GTAW), Plasma Arc Welding (PAW), Electron Beam Welding, Inertia Welding, Friction Stir Welding and others. GMAW, GTAW, and PAW processes use filler metals to accomplish the weld joining process. Electron Beam Welding and the other processes mentioned here do not typically use filler metals to accomplish welding, but they may in some instances. Thus, the filler metals disclosed herein are applicable to all weld joining processes.

Today, arc welding is the most commonly used welding process. It joins metal components by melting a portion of the base metal(s) to be joined and melting a filler metal, which is usually in the form of a wire, to create a molten weld pool at the joint. The filler metals currently available for welding aluminum are subject to alteration of their mechanical properties during the welding process. The variables present during welding affect the resulting mechanical and physical properties of the finished weld joint. Such variables include, for example, joint design, base metal section size, heat input, and penetration of the weld bead into the base metal with the resultant variation of the amount of base metal dilution into the filler metal puddle. The properties of existing filler metals for aluminum can result in a severe limitation of the mechanical and physical properties of aluminum structures that can be consistently and reliably produced in modern manufacturing operations.

That is, in service, welds in aluminum structures can fail under dynamic or static loading. The aluminum structures can fail from many factors, such as impact loading or fatigue. Failure in the weld joint is accelerated by discontinuities or structural defects that are often present in the weld joint. Therefore, it is important that any filler metal used to weld structural components have a higher mechanical strength than the base metals to be joined so that failures, if they are to occur, are directed to the base material where there are far fewer discontinuities. Existing aluminum welding filler metals frequently do not provide the mechanical strength advantage and, consequently, weld joints become the weakest link in aluminum-welded structures. As a result, welding design engineers are constantly seeking welding filler metals with higher as-welded strength to improve the life of their welded structures and provide additional degrees of safety for their welded products.

Aluminum filler metals have been developed since the conception of arc-welding processes. The popular aluminum filler metals in use today were developed to weld specific wrought or cast alloys simply by slightly modifying the composition of the base metals to be joined. For the 5xxx series (aluminum/magnesium) filler metal alloys, these modifications were mainly done by adjusting base metal chemistries in order to achieve a filler metal chemistry that compensates for burn-off of certain alloying elements, such as magnesium (Mg), in the welding arc. Most of the 4xxx series (aluminum/silicon) filler metal alloys were created by adapting already existing brazing alloys. The resulting filler metals have severe limitations in their ability to provide consistent reliable mechanical and physical properties in welds when subjected to the many variables present in the welding process.

Heat generated by welding processes, and in particular arc welding of aluminum, has always been a negative to be dealt with. Heat causes deterioration of the mechanical and sometimes the physical properties of both the weld joint and the heat effected zone of the base metal. This is true for both heat treatable and non-heat treatable aluminum alloys. None of the existing aluminum filler metal alloys has specifically formulated metallurgy that develops significant as-welded mechanical and physical properties that exceed the properties of the base metal in all welding conditions. To achieve this, the metallurgy of the alloy must be designed to take advantage of the unique sequence of thermal events that takes place in the welding process, namely that of melting, rapid solidification, and rapid cooling rate. These cooling rates must be fast enough to meet the time-temperature-transformation limit of the fine constituent requirements in the weld to produce the desired mechanical and physical properties on a consistent and reliable basis. Another consideration is that the chemical composition of filler metals that are to be used in the form of wire or rods must have the mechanical properties that allow it to be fabricated into wire. This has been a limiting factor in developing higher strength 5xxx series filler metal alloys.

There is a desire in the aluminum welded structures industry to have weld filler metals that not only produce superior strength, but also provide superior corrosion resistance and that match the base metal's anodized color when anodized after welding. Yet another consideration is to design aluminum welding filler metals that have the corrosion resistance and anodizing characteristics that are desired. The rapid advancement in the use of aluminum to produce automobiles, trucks, trailers, high-speed trains, rail cars, ships, military vehicles, rockets, missiles, satellites and many other products, demands the development of new filler metals with increased mechanical and superior physical properties to meet the demands of these products. The novel metal alloy composition disclosed herein, which may be used as a filler metal in aluminum welding applications, hereinafter, filler composition, is applicable to innumerable weld joining processes, including, without limitation, those disclosed herein.

### SUMMARY OF THE INVENTION

The invention relates to welding high strength aluminum structures, and more particularly to the filler metal alloy compositions suitable for the welding process and superior weldment physical and mechanical properties, substantially as illustrated by and/or described in connection with at least one of the Figures, as set forth more completely in the claims.

According to a first aspect of the present invention, a metal alloy composition for use in a welding process comprises: silicon in a weight percentage of between 0.10% and 5.0%; and magnesium in a weight percentage of between 1.0% and 15.0%, with a remainder of aluminum, other alloying elements, and trace elements. The weight percentage of aluminum may be, for example, in a weight percentage of between 70.0% and 98.9%. In other aspects, the aluminum may be in a weight percentage of between 75.0% and 98.9%. In yet another aspect, by weight percentage, the aluminum is between 75.0% and 96.8%, the silicon is between 0.20% and 3.5%, and the magnesium is between 3.0% and 11.0%. In certain aspects, the metal alloy composition further comprises: manganese in a weight percentage of between 0.05% and 1.5%; chromium in a weight percentage of between 0.05% and 0.35%; titanium in a weight percentage of between 0.003% and 0.20%; zirconium in a weight percentage of between 0.05% and 0.40%; boron in a weight percentage of between 0.001% and 0.030%; and phosphorous in a weight percentage of 0.50% maximum.

According to a second aspect of the present invention, a metal alloy composition for use in a welding process comprises: silicon in a weight percentage of between approximately 0.10% and 5.0%; iron in a weight percentage of 0.05% maximum; copper in a weight percentage of 0.05% maximum; manganese in a weight percentage of between approximately 0.05% and 1.5%; magnesium in a weight percentage of between approximately 1.0% and 15.0%; chromium in a weight percentage of between approximately 0.05% and 0.35%; zinc in a weight percentage of 0.30% maximum; titanium in a weight percentage of between approximately 0.003% and 0.20%; boron in a weight percentage of between approximately 0.001% and 0.030%; zirconium in a weight percentage of between approximately 0.05% and 0.40%; beryllium in a weight percentage of 0.001% maximum; and phosphorous in a weight percentage of 0.5% maximum, with a remainder of aluminum and trace elements.

According to a third aspect of the present invention, a weldment comprises: a first base metal; a second base metal; and a filler metal alloy, wherein the filler metal alloy fuses the first base metal to the second base metal, wherein the filler metal alloy comprises silicon in a weight percentage of between approximately 0.20% and 3.5%; iron in a weight percentage of 0.05% maximum; copper in a weight percentage of 0.05% maximum; manganese in a weight percentage of between approximately 0.05% and 1.5%; magnesium in a weight percentage of between approximately 3.0% and 11.0%; chromium in a weight percentage of between approximately 0.05% and 0.35%; zinc in a weight percentage of 0.30% maximum; titanium in a weight percentage of between approximately 0.003% and 0.20%; boron in a weight percentage of between approximately 0.001% and 0.030%; zirconium in a weight percentage of between approximately 0.05% and 0.40%; beryllium in a weight percentage of 0.001% maximum; and phosphorous in a weight percentage of 0.5% maximum, with a remainder of aluminum and trace elements.

According to a fourth aspect of the present invention, a method of manufacturing a filler metal for welding aluminum materials comprises: plastically deforming a metal alloy to form the filler metal, the metal alloy comprising aluminum in a weight percentage of between 70.0% and 98.9%, silicon in a weight percentage of between 0.10% and 5.0%, and magnesium in a weight percentage of between 1.0% and 15.0%.

According to a fifth aspect of the present invention, a weldment comprises: a first base metal; and a second base metal bonded to the first base metal at a weld joint, wherein the weld joint is formed via a welding process using a filler metal comprising aluminum in a weight percentage of between 70.0% and 98.9%, silicon in a weight percentage of between 0.10% and 5.0%, and magnesium in a weight percentage of between 1.0% and 15.0%.

In certain aspects by weight percentage, the silicon is between approximately 0.50% and 0.80%, the manganese is between approximately 0.05% and 0.50%, the magnesium is between approximately 5.6% and 6.3%, the chromium is between approximately 0.05% and 0.20%, the zirconium is between approximately 0.05% and 0.15%, the titanium is between approximately 0.003% and 0.10%, the boron is between approximately 0.001% and 0.010%, and the phosphorous is 0.05% maximum.

In certain aspects by weight percentage, the silicon is between approximately 0.30% and 0.50%, the manganese is between approximately 0.50% and 1.0%, the magnesium is between approximately 3.3% and 3.8%, the chromium is between approximately 0.05% and 0.20%, the zirconium is between approximately 0.05% and 0.20%, the titanium is between approximately 0.003% and 0.10%, the boron is between approximately 0.001% and 0.01%, and the phosphorous is 0.05% maximum.

In certain aspects by weight percentage, the silicon is between approximately 2.50% and 3.10%, the manganese is between approximately 0.20% and 0.50%, the magnesium is between approximately 9.0% and 10.4%, the chromium is between approximately 0.05% and 0.20%, the zirconium is between approximately 0.05% and 0.20%, the titanium is between approximately 0.003% and 0.10%, the boron is between approximately 0.001% and 0.01%, and the phosphorous is 0.05% maximum.

In certain aspects by weight percentage, the silicon is between approximately 2.50% and 3.10%, the manganese is between approximately 0.40% and 0.70%, the magnesium is between approximately 4.2% and 5.2%, the chromium is between approximately 0.05% and 0.20%, the zirconium is between approximately 0.05% and 0.20%, the titanium is between approximately 0.003% and 0.10%, the boron is between approximately 0.001% and 0.01% and the phosphorus is 0.05% maximum.

In certain aspects, the metal alloy composition is a 5xxx series or a 6xxx series aluminum filler metal alloy for welding 3xxx, 5xxx, 6xxx, and 7xxx series aluminum metal.

In certain aspects, the metal alloy composition is a 5xxx series or a 6xxx series aluminum filler metal alloy for use with elevated temperature applications of up to 250 degrees Fahrenheit.

In certain aspects, the metal alloy composition is a 5xxx series or a 6xxx series aluminum filler metal alloy that provides color matching for post-weld anodizing treatments.

In certain aspects, the metal alloy composition is a 5xxx series or a 6xxx series aluminum filler metal alloy having corrosion protection properties that match, or exceed, those of a base aluminum alloy component being welded.

In certain aspects, the metal alloy composition is a 5xxx series or a 6xxx series aluminum filler metal alloy having an electrical conductivity of approximately 20% International Annealed Copper Standard (IACS).

In certain aspects, the first base metal or the second base metal comprises at least one of: a 3xxx series aluminum metal; a 5xxx series aluminum metal; a 6xxx series aluminum metal; or a 7xxx series aluminum metal.

In certain aspects, the first base metal is a silicon-based aluminum casting alloy and the second base metal is a wrought aluminum alloy.

In another aspect, a chemical composition is disclosed that uniquely uses the welding process to create a super-heated saturated liquid composition of Aluminum plus Mg, Si, and Mn. When quenched to the solid state from the liquid saturated state onto the base metal in the weld joint, the Mn is retained in solid solution, excess magnesium is retained in solid solution and Mg₂Si is retained in solid solution, precipitates, and dispersoids. This is a unique metallurgical transformation, saturated liquid state to solid. It differs from solid state transformations in wrought alloys and develops improved physical and mechanical properties of the weld joint than currently available from filler alloys.

In another aspect, a chemical composition, within the 5xxx/6xxx alloy classifications, is disclosed that is capable of producing mechanical tensile and shear properties up to 20 percent above any commercially available filler metal as welded or post weld thermally treated. For example, the improved mechanical tensile properties may be up to 57 ksi (kilopound per square inch) and shear properties being up to 33 ksi can be achieved as compared with commercial 5xxx filler alloys such as 5356 with tensile properties of 38 ksi and shears properties of 23 ksi.

In another aspect, a chemical composition is disclosed that produces up to 20% higher fatigue initiation strength than other commercial 5xxx/6xxx filler metal alloys. For example, the improved fatigue strength may be up to 57 ksi initiation strength and up to a fatigue limit of 26 ksi at 500 million cycles.

In another aspect, a chemical composition is disclosed that has reduced electrical conductivity and higher resistivity than current 5xxx filler metals. Higher resistivity increases burn off rate of the filler wire in the electrical arc. Higher burn off rates increase welding deposition rates and increased welding productivity. For example, commercial 5xxx alloys such as 5356 have an electrical conductivity of 33 International Annealed Copper Standard (IACS), where the claimed chemical composition has a conductivity down to 25 IACS.

In another aspect, a chemical composition is disclosed that produces lower internal friction, higher fluidity, and reduced surface tension in the molten metal state, which improves weld bead contour and joint root wetting than any other commercial 5xxx/6xxx filler metal alloys. For example, the metal alloy composition produces higher fluidity up to (internal friction of 1.0 centipoise at 1292 deg. F), and reduced surface tension down to (570 dynes per cm at 1292) in the molten metal state, which improves weld bead contour and joint root wetting than can be achieved using existing commercially available 5xxx or 6xxx series aluminum welding filler metal.

In another aspect, a chemical composition is disclosed that produces lower out of solution hydrogen gas porosity in weldments than any other aluminum filler metal alloy. The metal alloy composition produces lower out of solution hydrogen gas porosity in weldments than 5xxx alloys such as 5356 or 5183 alloys. The porosity producing hydrogen content is measured in ml/100 g when weldments are made with similar arc hydrogen contents.

In another aspect, a chemical composition is disclosed that has solid solute or constituents that are controlled such that there are no significant differences in electro negativities. The potential volts of constituents and aluminum are controlled within ranges such that the weld metal has excellent intergranular corrosion, including stress corrosion, performance in salt-water. This chemistry provides a unique high strength and high corrosion resistance combination of properties for salt-water exposure. Pure Aluminum (99.95% Al) has potential volts of −0.85, Al+1% Mg₂Si has potential volts of −0.83, Al+5% mg had potential volts of −0.88 and Mg₂Si constituents have potential volts of −0.82. These potential volts are considered to be similar for intergranular and stress corrosion control. The potential volts of constituents, alloying element, and the aluminum are controlled within ranges such that the weld metal has excellent intergranular corrosion, including stress corrosion, performance in salt-water to provide a high strength and a high corrosion resistance combination of properties suitable for salt-water exposure.

In another aspect, a Mg₂Si containing filler metal chemistry is disclosed that has the content of Mg₂Si and free Mg concentrations controlled to provide a non-solidification crack sensitive filler metal. The low solidification crack sensitive chemistry allows the first application of Mg₂Si plus excess Mg alloy (6xxx) to be used for filler metal commercial applications.

In another aspect, a metal alloy composition is configured to be plastically deformed into a welding wire of one or more welding wire sizes by controlling the amount of free magnesium (free Mg) in solution with the addition of silicon (Si), whereby a specifically controlled amount of free Mg is combined with Si in the form of magnesium silicide (Mg₂Si). In other words, the amount of free Mg that is in solid solution may be controlled by adding specific amounts of Si that will combine with a portion of the Mg present in the liquid state into an intermetallic compound Mg₂Si upon solidification, thereby resulting in a controlled amount of free Mg left in solution when the liquid has solidified to gives the resultant alloy its ductility for mechanical forming operations. This constituent is controlled to in solution, precipitate, or dispersoids phases by thermal operations to facilitate plastic deformation during fabrication.

### BRIEF SUMMARY OF THE DRAWINGS

The description herein makes reference to the accompanying drawings wherein like reference numerals refer to like parts throughout the several views and wherein:

FIG. 1 is a table illustrating an exemplary chemical composition in accordance with an aspect of the present invention along with improved aluminum alloys 1, 2, 3, and 4

FIG. 2 is a graph illustrating the magnesium and silicon contents of the improved aluminum alloys 1, 2, 3, and 4.

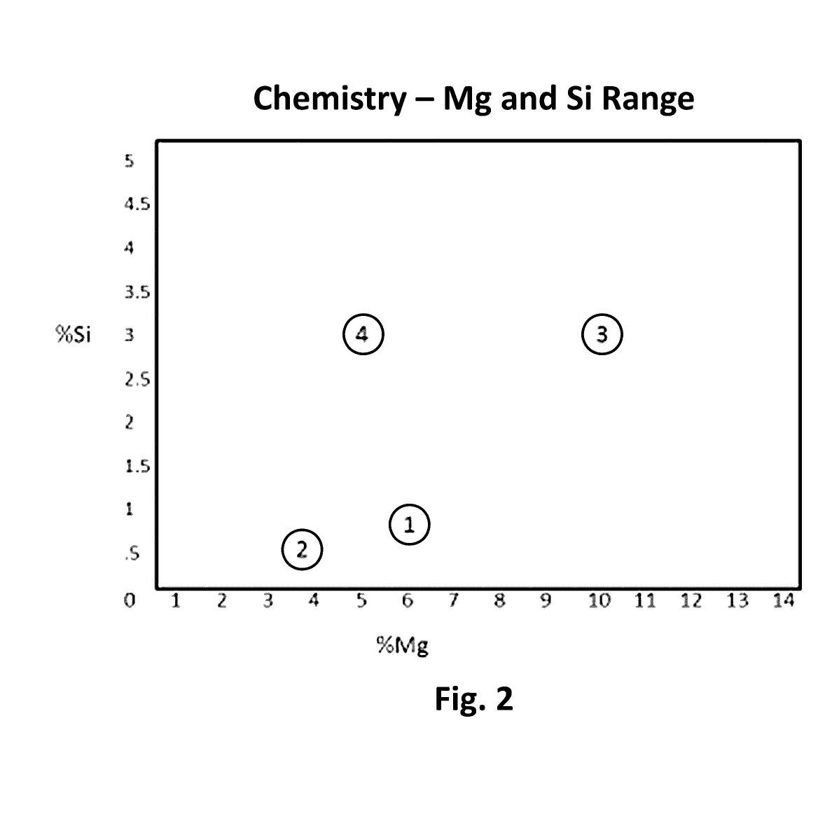

FIG. 3 is a graph illustrating a summary of the mechanical properties of improved aluminum alloys 1, 2, 3, and 4.

FIG. 4 is a graph illustrating the typical tensile and shear strengths of as-welded filler alloys along with the prophetic tensile and shear strengths of the improved aluminum alloys as welded.

FIG. 5 is a chart illustrating weldment cooling rates for varying welding heat inputs.

FIG. 6 is a graph illustrating the electrical conductivity of various aluminum alloys as it is affected by the percentage of alloying elements silicon and magnesium.

FIG. 7 is a chart illustrating the as-welded fatigue strength of various aluminum alloys.

FIG. 8 is a chart illustrating the electronegative potential of various solid solutes or constituents in aluminum alloys.

FIG. 9 is a drawing illustrating a typical fillet weld and butt weld joint.

FIG. 10 is a chart illustrating the effect of increasing alloy content on the fluidity of aluminum alloys.

FIG. 11 is a chart illustrating the effect of increasing alloy content on the surface tension of aluminum alloys.

FIG. 12 is a chart illustrating how Mg₂Si and free magnesium concentrations affect the hot cracking sensitivity of aluminum weldments.

### DETAILED DESCRIPTION OF THE ILLUSTRATIVE EMBODIMENT

Preferred embodiments of the present invention will be described here in below with reference to the figures of the accompanying drawings. Like reference numerals are used throughout the drawings to depict like or similar elements. In the following description, well known functions or constructions are not described in detail, since such descriptions would obscure the invention in unnecessary detail.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation. Further, some of the metallurgical and mechanical aspects of this invention are best illustrated through the use of graphical representations of the principals involved. Several figures have been included to illustrate certain aspects of this invention.

As used herein, the words “about” and “approximately,” when used to modify or describe a value (or range of values), mean reasonably close to that value or range of values. Thus, the embodiments described herein should not be limited to only the recited values and ranges of values, but rather should include reasonably workable deviations, which, unless otherwise indicated, may be a ten percent deviation.

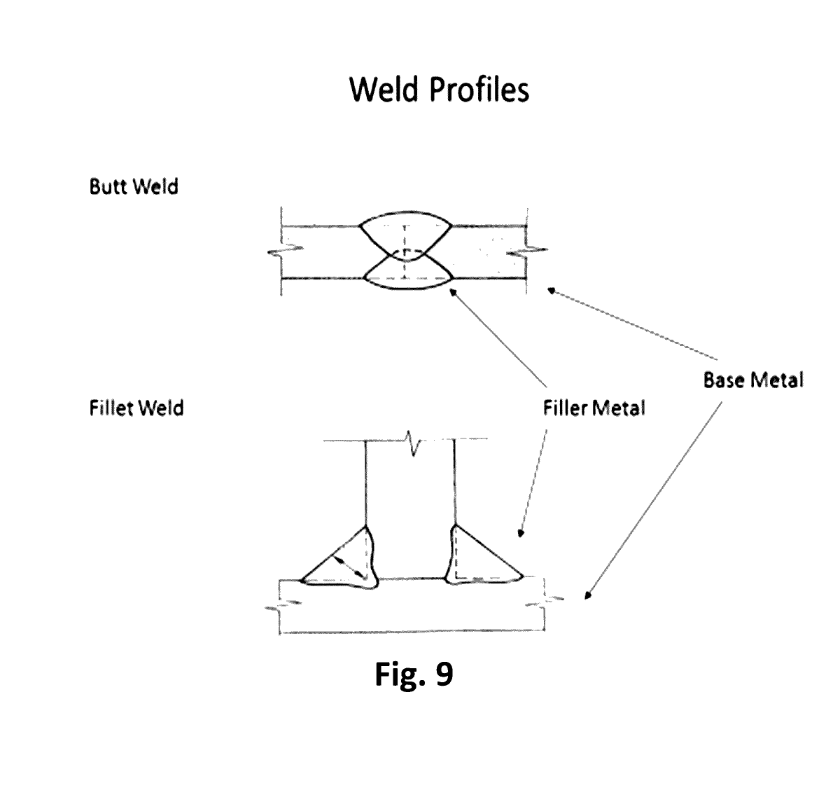

By way of background, an international classification system for aluminum alloys exists. The international classification system uses groups of four digits; the first digit indicates the major grouping based on the principal alloying element(s), while the other digits refer to the other features, such as composition. The primary groups are: (1) the 1xxx series (no majoring alloying element); (2) the 2xxx series (copper); (3) the 3xxx series (manganese); (4) the 4xxx series (silicon); (5) the 5xxx series (magnesium); (6) the 6xxx series (magnesium and silicon); (7) the 7xxx series (zinc); and (8) the 8xxx series (other alloys, such as Scandium (Sc), Lithium (Li), Iron (Fe), etc.). Historically, welding filler metal alloys for aluminum have been developed by simply adapting the compositions of already existing brazing alloys or by slightly modifying the chemistries of the cast or wrought alloys to be welded. In the case of the 4xxx series of welding alloys, most were adaptations of pre-existing brazing alloys. In the case of the filler metal alloys for welding cast alloys, they are simply a replication of the chemistry of the cast alloys to be welded, with some modifications for elements that will burn off during welding. In the case of the 5xxx series filler metal alloys, they also are a slightly modified chemistry of the 5xxx series wrought alloys to be welded. Consequently, welding engineers have historically struggled to produce welds where the strength of the weld joint significantly exceeds the strength of the base metals being welded. Because of the mechanical defects that are inherently present in all weld joints, it is critical for dynamically and in some cases statically loaded structures to have the strength of the weld joint metal exceed the strength of the base metals being joined. As illustrated by FIG. 9, which illustrates a typical fillet weld and butt weld joint, this becomes particularly relevant in fillet welds and in partially penetrated butt-joint welds. It is estimated that in general manufacturing operations, approximately 70% of all welds end up with partial penetration. In these cases, the weld metal bears all of the stress loads when in service. It becomes important that weld joints have superior strength and toughness if welded structures are to meet their designed service life. The improved aluminum alloys disclosed herein alleviate this limitation of the currently available families of aluminum welding filler metal alloys.

Indeed, heat generated during the welding process has always presented challenges. For instance, heat deteriorates the properties of the base metal in the heat affected zone. Until now, there have not been any 5xxx or 6xxx alloys registered with the Aluminum Association for welding (or listed in the American Welding Society (AWS) A5.10 filler metal specification for aluminum) that have been specifically designed to optimize their mechanical and physical properties by utilizing the thermal processes that are present in gas metal arc (GMA) and gas tungsten arc (GTA) welding operations. Additionally, while attempts have been made to produce higher strength 5xxx series welding filler metals, they have been limited because, as the strength of the alloys was increased through maximizing magnesium and manganese additions, the alloys very rapidly reached the point where the ductility of the alloy was lowered such that they could no longer be fabricated into welding wire or rods.

The improved aluminum alloy disclosed herein, a 5xxx or 6xxx series filler metal alloy, is designed so that it can be thermally processed in such a way as to allow the alloy to be drawn into welding wire of the popular sizes. The improved aluminum alloy is further designed so as to achieve maximum potential mechanical properties during the melting, rapid solidification, and subsequent rapid cooling to room temperature of the weld joint. For example, the improved aluminum alloy contains phosphorous that, in addition to the excess magnesium content, refines the magnesium silicide (Mg₂Si) constituent size and distribution as well as influencing the shape of the Mg₂Si particles that precipitate. Mg₂Si combine at a weight percentage of 1.73% Mg to 1% Si. In use, Mg₂Si is dissolved into a super saturated aluminum solution by the welding arc, heated to approximately 3,500 degrees F., quenched to the solid state in approximately 2 seconds retaining a significant portion of the Mg₂Si in solution in the −W/−T1 temper condition. Maximum solubility of Mg₂Si in aluminum in the solid state is 1.85%. The Mg₂Si is used for strengthening in solution −T1 and −T4, as a precipitate −T5 and −T6, and as a refined dispersoid. All phases and tempers as welded or post weld thermally treated provide measurable additive strengthening to the base metal chemistry properties.

Phosphorus aids in creating a spherical shaped precipitate. The weld process heating, to a temperature of about 3,500 degrees Fahrenheit, followed by a rapid cooling process, also promotes a small sized and finely distributed Mg₂Si dispersoid and precipitate. In addition, for alloys with less than 3% free magnesium, the Mg₂Si has a varying degree of solubility and contributes varying amounts of precipitation strengthening upon post weld solution heat treatment and aging.

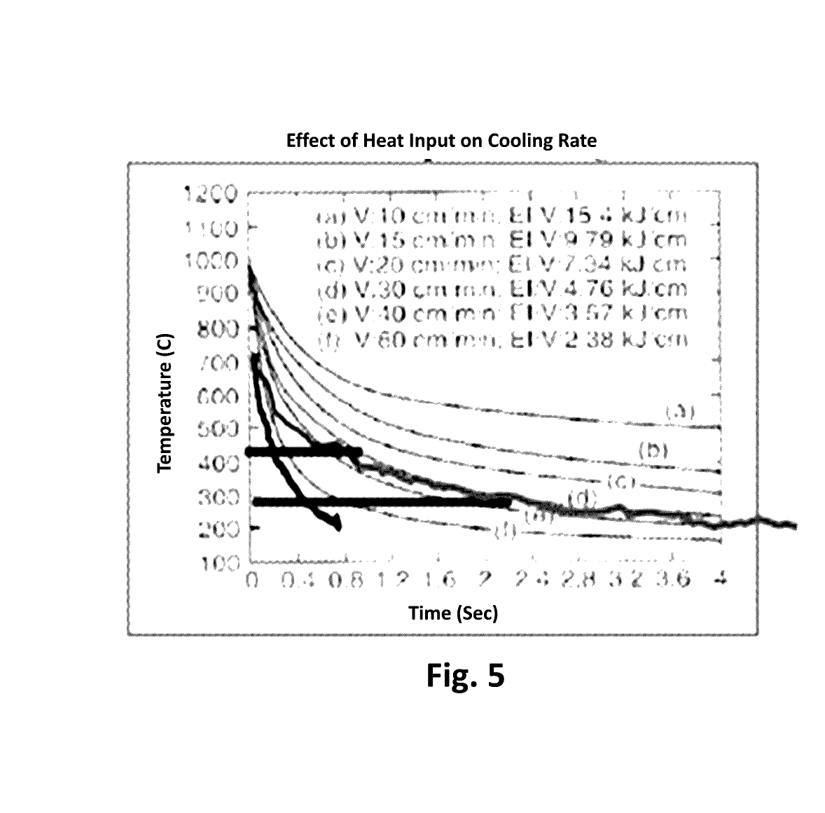

The improved aluminum alloy also adjusts the magnesium content in the alloy so that it can be used to weld 5454 base metal, a base metal developed by Alcoa for good strength and ductility characteristics when used in elevated temperature applications, as well as other base alloys that are used in elevated temperature applications up to 250 degrees F. Finally, the improved aluminum alloy can be used to weld the 6xxx series wrought alloys either by providing a precipitation response or by dispersion strengthening with a positive effect on thermal post-weld aging treatments. Post-weld aging of welded structures restores the mechanical properties of the base metal's heat affected zone so as to be close to that of the filler metal. Refer to FIG. 5 for the thermal input and cooling rates of aluminum weldments.

As a disclosed herein, an improved aluminum alloy composition in accordance with an aspect of the present invention may comprise silicon (Si) in a weight percentage of between approximately 0.10% and 5.0%, more preferably 0.20% and 3.5%; manganese (Mn) in a weight percentage of between approximately 0.05% and 1.5%, more preferably 0.05% and 1.4%, most preferably 0.05% and 1.2%%; magnesium (Mg) in a weight percentage of between approximately 1.0% and 15.0%, more preferably 3.0% and 11.0%; chromium (Cr) in a weight percentage of between approximately 0.05% and 0.35%, more preferably 0.05% and 0.2%; zirconium (Zr) in a weight percentage of between approximately 0.05% and 0.40%; titanium (Ti) in a weight percentage of between approximately 0.003% and 0.20%, more preferably 0.003% and 0.10%; and boron (B) in a weight percentage of between approximately 0.001% and 0.030%, more preferably 0.001% and 0.01%; and phosphorus (P) in a weight percentage of 0.5% maximum or, more preferably, 0.3% maximum, with a remainder of the alloy being aluminum and trace elements. Here, the weight percentage of aluminum may be, for example, in a weight percentage of between 70.0% and 98.746%, more preferably between 75.0% and 98.746%.

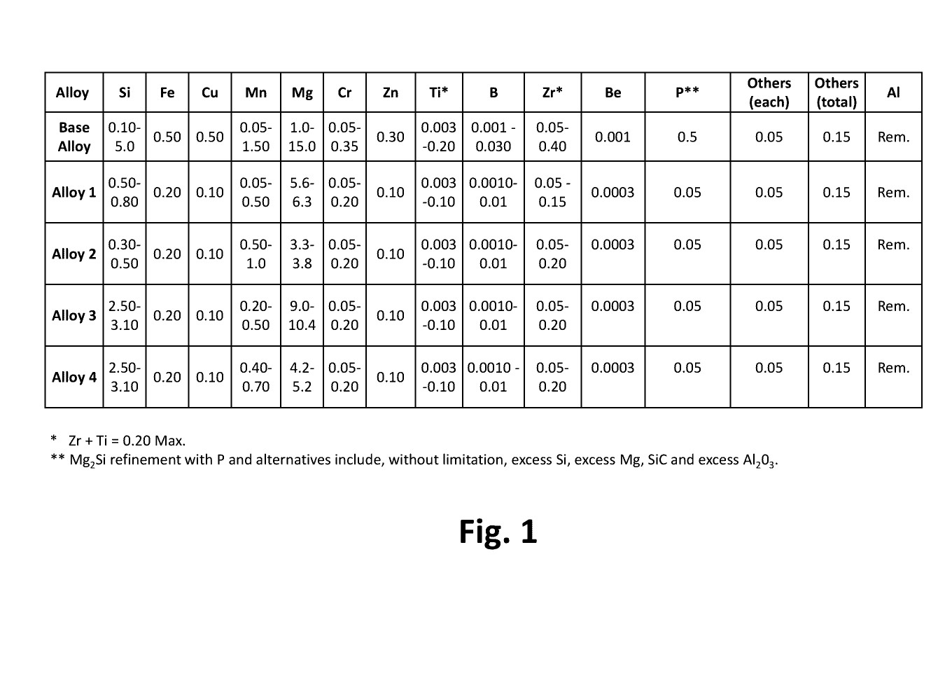

FIG. 1 is a table showing exemplary improved aluminum alloys in accordance with aspects of the present invention, specifically, improved aluminum alloys 1, 2, 3, and 4. Except for the trace elements, which are noted in FIG. 1 with a single maximum allowable percentage, the balance of the elements present in this new improved aluminum alloy composition have been intentionally added and controlled with specific percentage ranges in order to achieve the desired properties of this alloy. The exception to this is phosphorus, which may or may not be intentionally added. Reasons for the presence and percentage content of each of the intentionally added alloying elements will now be discussed with regard to each element. The other categories “each” and “total” refer to commercial maximum limits established by the Aluminum Association.

Silicon (Si)—The approximate silicon range of the alloy composition of between 0.1% and 5.0% by weight allows for the formation of Mg₂Si in amounts that will be out of solid solution as a dispersed constituent controlled by heating and cooling rates present during typical welding operations. Magnesium and silicon form Mg₂Si constituent out of solution with the constituent size and distribution controlled by the cooling rate, excess magnesium content and weight percentage of phosphorus present. The alloy is designed to promote Mg₂Si that is out of solution in solidified weldments. In addition to the out-of-solution constituents, there will be precipitation strengthening from the Mg₂Si as well as dispersion strengthening. As-welded precipitation strengthening effect will be maximized with no excess Mg. When quenched from the liquid state, some Mg₂Si will remain in solution and be available for precipitation hardening at all excess Mg levels.

Manganese (Mn)—Mn is added to Mg and Mg₂Si based alloys to improve the strengthening effectiveness of Mg additions. The approximate manganese range of the alloy composition of between 0.05% and 1.5% by weight, enhances mechanical properties through elemental solid-solution strengthening and is controlled to prevent reduced ductility and toughness. The addition of manganese increases mechanical properties when controlled to below its maximum solubility limit in aluminum. It provides added strength without reduction of corrosion resistance in salt-water applications. Moreover, Mn adds strength to Mg alloys at twice the rate as a similar Mg weight percent addition.

Magnesium (Mg)—The approximate magnesium range of the alloy composition of between 1.0% and 15.0% by weight, allows the formation of Mg₂Si dispersion constituent in amounts that remain as a fine dispersion at the solidification and cooling rates present during typical welding operations. In addition to the out-of-solution dispersoids, as-welded precipitation strengthening effect will be maximized with no excess Mg. When quenched from the liquid state, some Mg₂Si will remain in solution and be available for precipitation hardening at all excess Mg levels.

Further, at higher magnesium levels, excess as-welded precipitation strengthening effect will be increased by excess Mg magnesium that stays in elemental solid solution to provide enhanced mechanical and physical properties in addition to Mg₂Si strengthening and constituent refinement. The maximum free magnesium is controlled to prevent reduced corrosion characteristics in salt-water exposure applications.

Chromium (Cr)—The approximate Cr range of the alloy composition of between 0.05% and 0.35% by weight is added to control grain structure and to prevent recrystallization. This range improves corrosion resistance and toughness. Above 0.35% Cr forms coarse constituents with other impurities or additions such as Mn, Fe, Zr, or Ti. These very course large constituent phases reduce toughness of the metal and make the fabrication of wire difficult to impossible.

Zirconium (Zr)—The approximate Zr range of the alloy composition is controlled for grain refinement and improving the resistance to solidification cracking in weldments. The Zr may be between 0.05% and 0.40% by weight, or more preferably 0.05% and 0.30%.

Titanium (Ti) and Boron (B)—The approximate Ti and B ranges of the alloy composition with the approximate Ti range of between 0.003% and 0.20% by weight and the approximate B range of between 0.001% and 0.020% by weight are used in combination to control grain structure size and shape in weldments. This cast structure improves stress corrosion cracking, toughness, and ductility. Ti, however, tends to form coarse constituents with Cr. With the addition of very small amounts of B, the Ti addition can be minimized without the loss of its grain refinement effects.

Ti, B, Cr, and Zr may be added to aluminum in various amounts or combinations to provide grain refinement and grain structure control. The additions affect strength, solidification cracking, corrosion, toughness, conductivity, and other physical properties. Grain refinement and control is not limited to these element additions. For example, titanium carbide (TiC), silicon carbide (SiC), and other insoluble constituents may be used to provide grain refinement.

Zirconium (Zr)+Titanium (Ti)—In the alloy composition, Zr has a maximum limit set at 0.40% and Ti has its maximum limit set at 0.20%. Zr, Ti, B, and Mn form coarse constituents with Cr. In coarse Cr constituent calculations, Zr and Ti are the greatest negative contributors to constituent formation that takes place with Cr. Therefore, Zr plus Ti has been controlled with maximum amounts.

Phosphorous (P)—P is added to excess bearing Mg₂Si containing alloys to refine the size and distribution of the Mg₂Si dispersoids. A fine dispersion has elevated strength and corrosion resistance properties. In the alloy composition, P has been controlled with a maximum addition amount of 0.5% by weight and is controlled for constituent refinement of the Mg₂Si phase. Phosphorous, as well as Si, Mg, and constituents including SiC, and Aluminum oxide (Al₂O₃), refine the size and distribution of Mg₂Si during solidification and cooling. Because of the necessity of shaving in the manufacturing process of the electrode, P has been initially chosen for constituent refinement while recognizing that other elements and constituents also provide Mg₂Si refinement. Alternative refinement additions include, without limitation, excess Si, excess Mg, excess Al₂O₃ and SiC.

Iron (Fe)—Fe is a commercial impurity and forms negative compounds with other elements. In the alloy composition, Fe has a maximum limit set at 0.50%, more preferably 0.40%, which may vary with code and with individual smelter ore sources.

Copper (Cu)—Cu is an effective strengthener, but is not added to excess Mg alloys because Cu and Mg form a detrimental precipitate. Therefore, in the alloy composition, Cu has a maximum limit set at 0.50%, more preferably 0.40%.

Zinc (Zn)—Zn is another effective strengthener for Mg based alloys. In the alloy composition, Zn has a maximum limit set at 0.30%, more preferably 0.25%, most preferably 0.1%.

Beryllium (Be)—Be is controlled to very low levels in aluminum welding materials. Be generates toxic welding fumes with levels above specification maximums. Therefore, in the alloy composition, Be has a maximum limit set at 0.001%, more preferably at 0.0008%, most preferably at 0.0003%.

Within the chemical range of the alloy composition, many specific alloys can be formulated, which have the basic metallurgical properties of the improved aluminum alloy but can be tailored to meet specific properties. For example, a specific chemistry can be selected to be used for elevated temperature service, or for matching of corrosion resistance properties of the cast or wrought alloys being joined, or for giving good anodizing color matching with the alloys being welded.

In accordance with one aspect of the invention, an alloy composition is provided for welding the 5xxx, and 7xxx casting alloys and all of the 5xxx series of non-heat treatable wrought alloys except for alloy 5454 or other alloys intended for elevated temperature service. This is an alloy comprising silicon in a weight percent of between approximately 0.50% and 0.80%; manganese in a weight percentage of between approximately 0.05% and 0.50%; magnesium in a weight percent of between approximately 5.6% and 6.3%; Cr in a weight percent of between approximately 0.05% and 0.20%; Zr in a weight percent of between approximately 0.05% and 0.15%; Ti in a weight percent of between approximately 0.003% and 0.10%; and B in a weight percent of between approximately 0.001% and 0.01%; with a remainder of aluminum and trace elements (see FIG. 1 for the full chemical analysis). This new improved aluminum alloy referred to as Alloy 1 can replace existing welding filler metal alloys 5356, 5183, and 5556 for all applications. Alloy 1 provides welds that have significantly higher as-welded mechanical properties. Higher tensile, yield, shear, and fatigue strengths allows aluminum to be used in new higher strength applications. Alloy 1 allows currently designed welded structures to experience fewer structural failures in service. Alloy 1; is designed but not limited to applications that require high tensile and shear strength, high resistance to salt-water intergranular corrosion. Typical applications include, without limitation, shipbuilding and mechanical dynamically loaded structures.

In accordance with another aspect of the invention, an alloy composition is provided for welding the corresponding Cu free 3xx, 5xx, and 7xx casting alloys and alloy 5454 as well as other 3xxx, 5xxx, or 6xxx series wrought alloys intended for use at elevated temperatures up to 250 degrees F. This is an alloy comprising silicon in a weight percent of between approximately 0.30% and 0.50%; manganese in a weight percent of between approximately 0.50% and 1.0%; magnesium in a weight percent of between approximately 3.3% and 3.8%; Cr in a weight percent of between approximately 0.05% and 0.20%; Zr in a weight percent of between approximately 0.05% and 0.20%; Ti in a weight percent of between approximately 0.003% and 0.10%; B in a weight percent of between approximately 0.001% and 0.01%; and P in a weight percentage of 0.050% maximum with a remainder of aluminum and trace elements (see FIG. 1 for the full chemical analysis). This alloy composition will be referred to as Alloy 2 and provides higher tensile, yield, shear, and fatigue strengths for elevated temperature applications. Alloy 2 is designed for applications that benefit from tensile and shear strength, high corrosion resistance, and resistance to elevated temperature corrosion. It allows currently designed welded structures, used at elevated temperatures, to experience fewer structural failures in service. This alloy is capable of welding silicon based casting alloys to wrought alloys with less than 3% magnesium. Aluminum/Magnesium alloys containing above 3.2% Mg should not be used in applications subject to elevated temperatures that exceed 180 degrees F. since these alloys can fail due to the long-term precipitation of an AlMg anodic phase in the grain boundaries of the metal. Alloy 2, however, not only yields a higher strength, but can also be used in the temperature range up to 250 degree F., which is advantageous in certain applications, such as wheels, engine cradles, heat exchangers, etc. However, it should be noted that long-term exposure to temperatures above 250/300 degrees F. will reduce the strength of both work hardened and precipitation hardened tempers. In complex designs such as automobile or truck structures, where silicon based castings are welded to wrought alloys with less than 3% magnesium, there are currently only two choices of filler metal available. The choices are the use of a low strength 4xxx series filler metal alloy or 5554 filler metal. Alloy 2 allows welding of silicon based aluminum castings to wrought 6xxx and 5xxx series alloys with significantly higher mechanical properties in the weld joint. Typical applications include, without limitation, automotive engine cradles, wheels, heat exchangers, and elevated temperature applications. Alloy 2 is also suitable for a post-weld artificial age.

In accordance with another aspect of the invention, an alloy composition is provided, which is referred to as alloy 3. Alloy 3 comprises silicon in a weight percent of between approximately 2.50% and 3.10%; manganese in a weight percent of between approximately 0.20% and 0.5%; magnesium in a weight percent of between approximately 9.0% and 10.4%; Cr in a weight percent of between approximately 0.05% and 0.20%; Zr in a weight percent of between approximately 0.05% and 0.20%; Ti in a weight percent of between approximately 0.003% and 0.10%; B in a weight percent of between approximately 0.001% and 0.01%; and P in a weight percentage of 0.050% maximum with a remainder of aluminum and trace elements (see FIG. 1 for the full chemical analysis). Alloy 3 is designed for applications that benefit from the highest available tensile and shear strengths, with good corrosion resistance. Typical applications include, without limitation, high performance structures such as aerospace, trains, pressure vessels, armor-shear strength components.

In accordance with another aspect of the invention, an alloy composition is provided, which is referred to as alloy 4. Alloy 4 comprises silicon in a weight percent of between approximately 2.50% and 3.10%; manganese in a weight percent of between approximately 0.40% and 0.7%; magnesium in a weight percent of between approximately 4.2% and 5.2%; Cr in a weight percent of between approximately 0.05% and 0.20%; Zr in a weight percent of between approximately 0.05% and 0.20%; Ti in a weight percent of between approximately 0.003% and 0.10%; B in a weight percent of between approximately 0.001% and 0.01%; and P in a weight percentage of 0.050% maximum with a remainder of aluminum and trace elements (see FIG. 1 for the full chemical analysis). Alloy 4 is designed for applications that benefit from high tensile and shear strengths, with high toughness, and applications where post weld thermal treatments are desired. In Mg₂Si bearing alloys, the amount of excess free magnesium controls the solubility of Mg₂Si in the aluminum. Alloy 4 employs a minimum of free magnesium allowing the solubility maximum in aluminum of 1.85% by weight of Mg₂Si to provide precipitation strengthening (see FIG. 1 for the full chemical analysis). For reference, at 3% free magnesium, the amount of solubility of Mg₂Si in aluminum is reduced to zero upon solution heat treatment. Alloy 4 is designed to utilize 0% free magnesium and an 8% by weight amount of Mg₂Si. With this composition, 1.85% of the Mg₂Si will be strengthening by precipitation hardening and the remaining 6.2% of the Mg₂Si will be strengthening as a dispersed particle constituent in both quenched from liquid, as welded, or post-weld solution heat treated. There will be no free magnesium solution strengthening, but manganese is added as a solution-strengthening element. Manganese does not affect the solubility of Mg₂Si in aluminum. Typical applications include, without limitation, armor, aerospace, and automotive in areas designed for impact resistance. Free Mg is minimized to facilitate post-weld solution heat treatment and artificial age physical properties.

Alloys 1, 2, 3, and 4, can be used to weld the 3xxx, 5xxx, 6xxx, and 7xxx series aluminum alloy components. The alloys provide weldments with higher as-welded tensile, yield, shear, and fatigue strengths than any filler metal available in the AWS filler metal specifications. The improved alloys 1, 2, and 3 are not heat treatable, but the alloys can be post-weld aged with positive effect. Post-weld aging has a positive effect on the filler alloy and it brings the mechanical properties of the base metal in the weld's heat affected zone close to the rest of the base metals heat treated properties and close to the as-welded properties of the filler metal. Specifically designed into alloy 4, is the ability to post-weld thermally treat weldments. Alloy 4 responds well to post-weld aging only and to full solution, quench, and age heat treatment processes. Historically, only some 4xxx series filler metals would respond to post-weld thermal treatments when welding 6xxx series alloys. The resultant welds have very low fracture toughness with high crack growth sensitivity. This loss of toughness has precluded the use of 6xxx series alloys in many welded applications where toughness and fracture characteristics are important design criteria. All 4xxx alloys experience a significant loss of toughness with post-weld thermal treatments. This invention addresses this limitation of the currently available families of aluminum welding alloys. Improved alloys 1, 2, 3, and 4 selected from the invention have significantly higher toughness than any 4xxx filler alloy as-welded or after appropriate thermal treatments. If mechanical properties and fracture toughness can be greatly increased, the size of weld beads in existing structures can potentially be reduced to achieve a cost savings in welding filler material and increased welding speeds.

Alloys 1, 2, 3, and 4 are only a few of the compositions, which can be formulated from the broader range of chemistries included in the composition of this improved aluminum alloy. There are any number of alloy compositions that can be formulated within the limits of the broader composition to achieve maximum performance of mechanical properties, and other properties such as corrosion resistance or color matching to the aluminum alloys being welded when post-weld anodizing is performed, or to adjust metallurgical properties to provide superior elevated temperature performance up to 250 degrees F.

In addition to this, chemistries (e.g., ratios/percentages) can be adjusted to provide other advantageous welding performance properties such as electrode burn-off rate, cold metal short-arc transfer, bead droplet performance in the welding arc, improved weld bead penetration, or improved fluidity and reduced melting/freezing temperatures of the weld filler metal etc. The ability to adjust these welding parameter characteristics of the filler metal affects the shielding gas that is required to achieve desired end results and can result in substantial cost savings.

The improved aluminum alloy composition provides an aluminum welding filler metal comprised of a spooled or a linear wire cut to length, or any other electrode or filler metal shape that is to be melted and fused to aluminum alloy components that are to be joined together by welding. This invention is intended to cover all new methods of weld joining where a filler metal is utilized or where a layer of bonding metal is used between aluminum alloy components and is subsequently melted to join them.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying figures, the latter being briefly described hereinafter.

Aluminum alloys are divided into two categories, heat treatable and non-heat treatable. The 6xxx series wrought alloys are heat treatable. The principal strengthening mechanism in these alloys is achieved through dissolving silicon and magnesium into solution through a solution heat treatment operation, then quenching to lock them in solution at room temperature. The alloy is then artificially aged at elevated temperatures to precipitate out Mg₂Si as coherent homogeneously dispersed particles that stress and thereby strengthen the microstructure. The subject alloy in the excess magnesium above 3% range prevents the dissolution of Mg₂Si and the subsequent precipitation in wrought alloy fabrication. When quenching from a liquid, the Mg₂Si forms as a fine constituent and provides strengthening by dispersion hardening in addition to precipitation strengthening at higher free Mg contents. In the alloy where the excess magnesium is less than 3%, solubility of Mg₂Si is present upon thermal treatment and increased precipitation strengthening occurs in addition to the dispersion and solution strengthening. Non-heat treatable alloys such as the 3xxx, 4xxx, and 5xxx series alloys achieve their mechanical properties through solid solution strengthening of the dissolved alloying elements, primarily manganese in the case of 3xxx series alloys, silicon in the case of the 4xxx series alloys and magnesium plus manganese in the case of the 5xxx series alloys. These alloys achieve additional strength through cold working operations. However, in the as-welded condition the 3xxx, 4xxx, and 5xxx series filler metals obtain their strength solely by solid solution strengthening of their principal alloying elements since no cold working is done after welding. For the improved aluminum alloy, the as-welded condition obtains its strength through dispersion and precipitation strengthening of the Mg₂Si plus the solution strengthening of the excess magnesium and manganese. The strengthening mechanism of the combination of Mg₂Si with the addition of excess magnesium at varying levels in the improved aluminum alloy composition was chosen to achieve the desired properties in the welding filler metal in accordance with an aspect of the present invention.

Various levels of Mg₂Si, not present as a precipitate but present as dispersoids, have also been chosen to achieve the desired as-welded properties. The presence of Mg₂Si that exceeds the solubility limit of 1.85% manifests itself in the as-welded microstructure as heterogeneous dispersion of Mg₂Si that does not respond to thermal treatments. The alloy's excess magnesium is available for solid solution strengthening of the matrix. In the improved aluminum alloy composition, the limits of silicon content are set at approximately 0.10% to 5.0% by weight, the limits of manganese content are set at approximately 0.05% to 1.5% by weight and the limits of magnesium content in the improved aluminum alloy are set at approximately 1.0% to 15.0% by weight. For each alloy formulated within the limits of the improved aluminum alloy composition, the Mg₂Si content is set starting at 1% and free magnesium content controlled between 0% and 5.2%. The ratio by weight of magnesium to silicon in Mg₂Si is 1.73 to 1 and this ratio is used to calculate the proper alloy addition levels of magnesium and Si. The improved aluminum alloy composition uses the formation of Mg₂Si to remove magnesium from solution thereby controlling the free magnesium in solution in the alloy to the proper limit for corrosion property control of less than 5.2% by weight. This is important for the corrosion and stress corrosion properties of the weld filler metal alloy.

The improved aluminum alloy composition was designed to take advantage of the thermal processes present during welding operations. In both GMA and GTA welding processes, the filler metal is melted and solidified very rapidly with the time frame being generally less than two seconds and most commonly less than 1 second. This improved aluminum alloy composition was designed to utilize the rapid liquid-to-solid cooling rate of the welding process, which is often as much as one hundred times faster than that of casting operations. This rapid solidification rate produces a maximum quantity of fine Mg₂Si dispersoids and keeps some Mg₂Si in solution for precipitation hardening. The cooling rate that an aluminum alloy experiences after solidification down to room temperature is also critical for an alloy containing Mg₂Si precipitates when controlling the levels of Mg₂Si constituent and excess magnesium. Solidification cooling rate controls precipitation and dispersoid size and distribution. The metallurgy of the improved aluminum alloy composition was designed so as to create a quench sensitivity that was in concert with the cooling rates experienced in the welding process. The addition of P to the alloy's chemistry, in addition to the cooling rate and excess magnesium content, controls the size and distribution of the strengthening Mg₂Si dispersoid. The alloy's chemistry was further controlled to optimize the effects of thermal energy that is introduced by multiple welding passes. Fe in particular forms negative phases with any solidification and post solidification cooling rate and can only be controlled by chemistry restrictions. Therefore, the improved aluminum alloy composition has Fe content controlled below most filler metal alloy specifications.

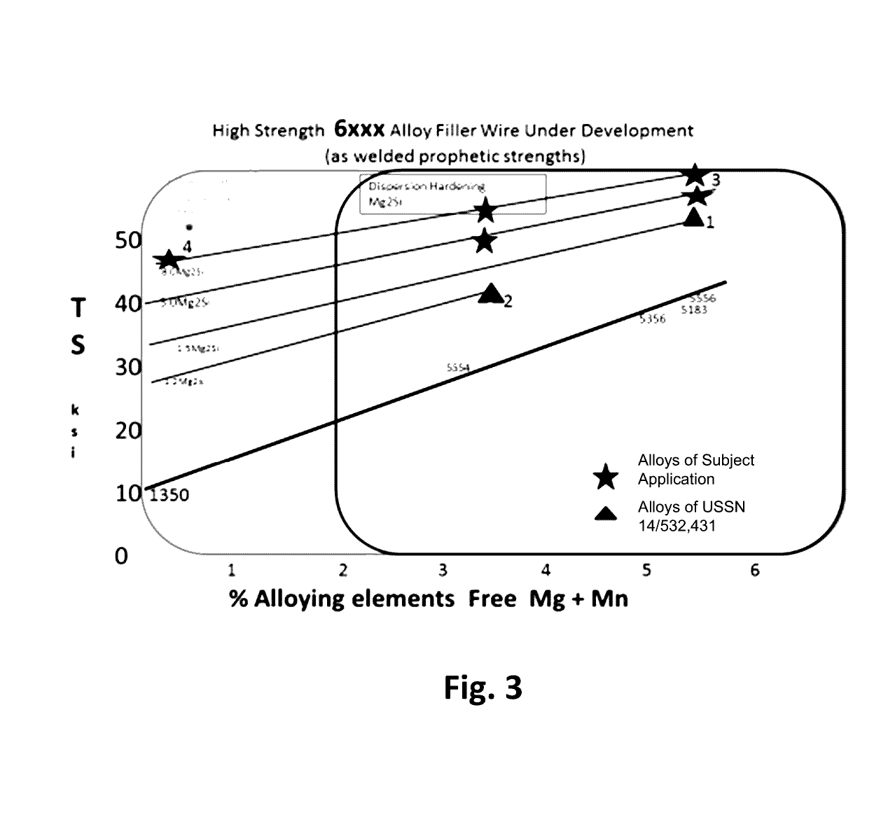

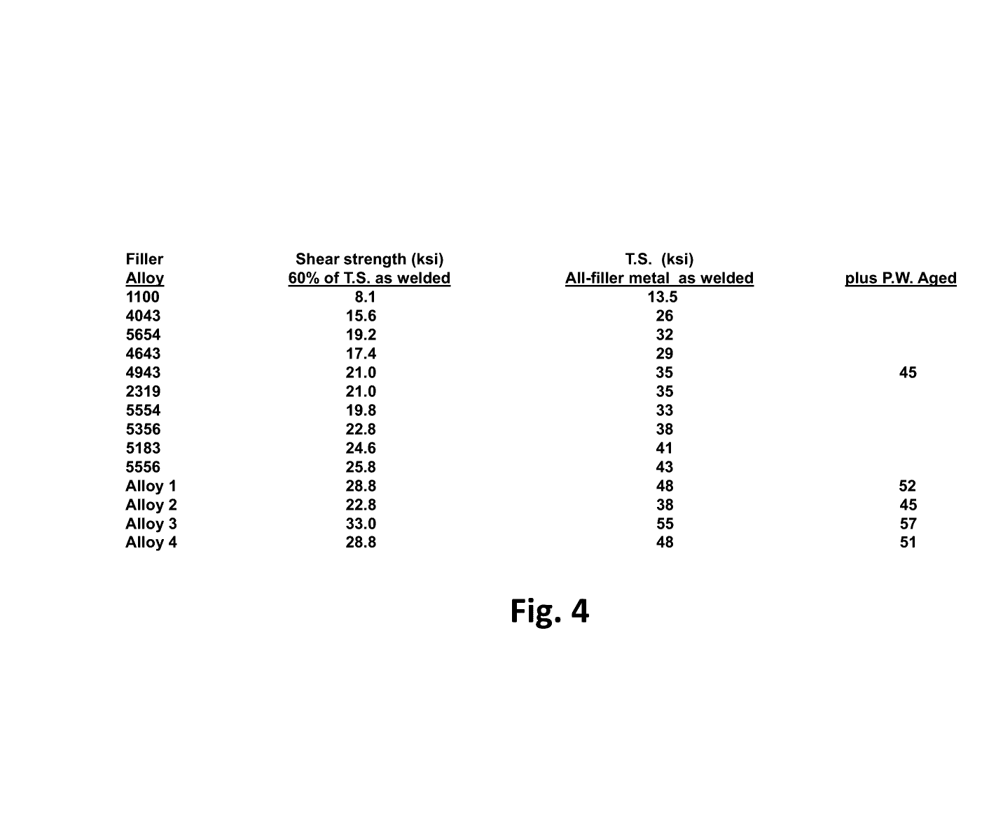

In FIG. 4, the tensile strength of the 5xxx series of welding filler metal alloys is compared to the prophetic tensile strengths of Alloys 1, 2, 3, and 4, which are shown as a band of possible post-weld tensile strengths achievable under most welding conditions. Specifically, FIG. 3 is a graph showing the tensile strength of various 5xxx series filler metal alloys as they vary with increasing percentages of the alloying elements magnesium and manganese in combination. The graphs show the zones of properties that are affected by dispersion, precipitation and solution strengthening. The charts show the areas of chemistry that are represented by the improved alloys as well as specific chemistries in the improved alloy range. Included on this graph is a band of prophetic properties that are achievable with the chosen improved aluminum alloys 1, 2, 3, and 4 chosen within the allowable limits and the prophetic properties that are achievable as-welded. The improved aluminum alloy will provide mechanical properties far above what is now available for similar applications. FIG. 3 is a graph showing a summary of mechanical properties for the selected alloys 1, 2, 3, and 4.

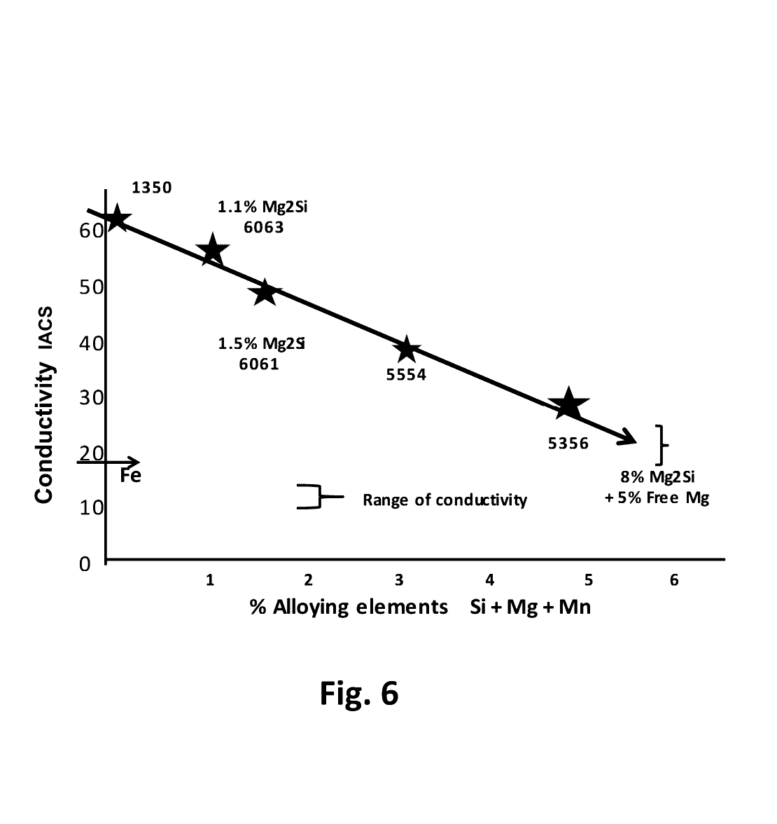

The chemistry of the new alloy contains maximum levels of free magnesium for another specific reason. Higher levels of free magnesium significantly increase the alloys resistivity. The melt-off rate of aluminum electrode is based on the welding parameters set into the welding equipment, the shielding gas, the mechanical stick out of the contact tip and electrode, and the physical properties of the electrode including the electrical resistivity of the metal in the electrode. Higher electrical resistivity provides increased heating of the wire as electricity is conducted through it. Higher resistivity of the electrode increases the melt-off rate. Further, aluminum is rarely used in the short-arc transfer welding mode. The resistivity is too low to provide a satisfactory burn-off rate during the short-arc portion of the metal transfer process. An objective of this invention is to increase the melt-off rate of the improved aluminum alloy composition in all metal transfer modes including globular, spray and short-arc transfer. FIG. 6 shows the effect of alloying elements on conductivity. Resistivity is the reciprocal of conductivity. Consequently, conductivity changes with the addition of alloying elements to aluminum and correlates directly to the electrical resistivity of the resulting alloy. Pure aluminum such as alloy 1350 has a conductivity of 62% IACS (international annealed copper standard). For reference purposes, copper has a conductivity rating of 100% IACS and iron is down at 18% IACS. For aluminum, a 1.5% Mg₂Si alloy has a 49% IACS, a 3% magnesium alloy a 40% IACS, and a 5% free magnesium alloy a 29% IACS value. For aluminum, if a typical 3.0 or 8.0% Mg₂Si alloy with an electrical conductivity of approximately 50% IACS has 5% free magnesium added to it, the resultant conductivity of the improved alloy is significantly reduced.

FIG. 5 is a chart showing weldment cooling rates for varying welding heat inputs. The critical cooling range for aluminum is illustrated. FIG. 5 illustrates a prophetic value of between 18% and 23% or a typical value of 20% IACS for the improved aluminum alloy composition. A 9-point reduction in conductivity from 29 to 20 represents a 31% relative reduction in conductivity from a straight 5% magnesium alloy or conversely, a 31% increase in resistivity. The improved aluminum alloy composition is approaching the conductivity of iron, which is 18% IACS. Iron has well documented melt-off rates and welding characteristics. Short-arc transfer is commonly used in welding steel, taking advantage of its high electrical resistivity. Specifically designed into this alloy is a conductivity that will facilitate short-arc and globular mode transfer. It should be noted that increased melt-off rate is a desired and intended result of the improved aluminum alloy composition. In all metal transfer modes, including spray transfer, increased melt-off rates facilitate welding with a decreased requirement for heat input from the welding equipment thereby reducing the negative effects of reduced mechanical properties in the heat affected zone. Less structural distortion is produced with less heat input as well. Further, electrodes with higher burn off rates can be welded at higher transfer rates increasing welding speeds and thereby reducing welding costs. By increasing the melting rate of the improved aluminum alloy composition through increased resistance heating, the thermal energy needed in the arc plasma has been reduced thereby reducing the amount of magnesium burn-off in the welding arc. Reduced heat input from the plasma due to increased resistance heating, allows for a more stable droplet transfer in the spray transfer mode, with less metal vaporization. The improved aluminum alloy composition reduces the amount or magnesium vapors in the arc plasma and the undesirable condensation of these vapors alongside the weld in the form of vapor condensate, known as smut. It is believed that magnesium vapors in the arc plasma affect the ionization potential of the shielding gas, which gives a different arc characteristic to high magnesium filler alloys as compared to other alloy series such as the silicon series filler metal alloys. Therefore, it is anticipated that the improved aluminum alloy allows the use of reduced levels of shielding gas necessary to achieve quality welds.

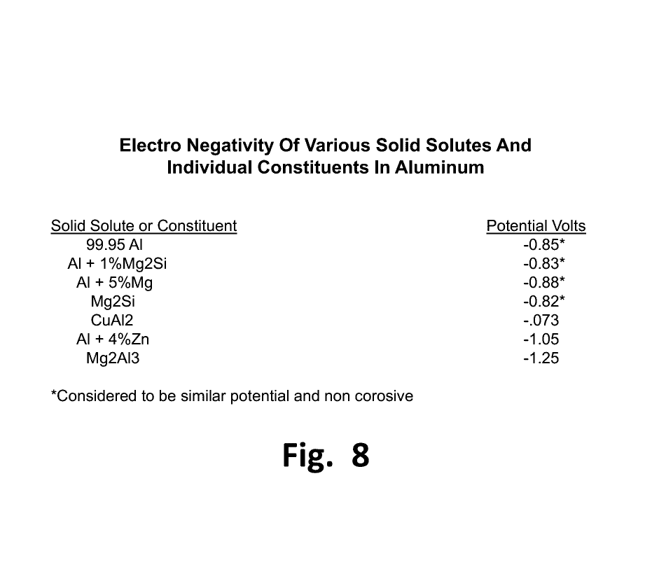

The improved aluminum alloy composition was also developed to control its corrosion characteristics. FIG. 8 shows the electro negativity of various solid solutes and individual constituents in aluminum. The base metal alloys to be welded with this filler metal are used for automotive, truck trailer, rail car, and ship building applications to name just a few. These structures spend their lives in harsh environmental atmospheres including the very corrosive effects of salt-water. The corrosion characteristics of aluminum filler materials are carefully controlled to insure suitability in a variety of service environments. The new alloys 1, 2, 3, and 4 are specifically designed to have controlled and excellent corrosion resistance as welded. They have an electro negative potential very close to that of pure aluminum. Mg₂Si is a constituent that has a potential similar to pure aluminum. The chemical content designed into the improved aluminum alloy composition has excellent as-welded corrosion properties. The alloy has excellent salt-water corrosion performance when welding the typical ship-building sheet and plate alloys, 5052, 5086, 5083, 6061, 6082, and 6351.

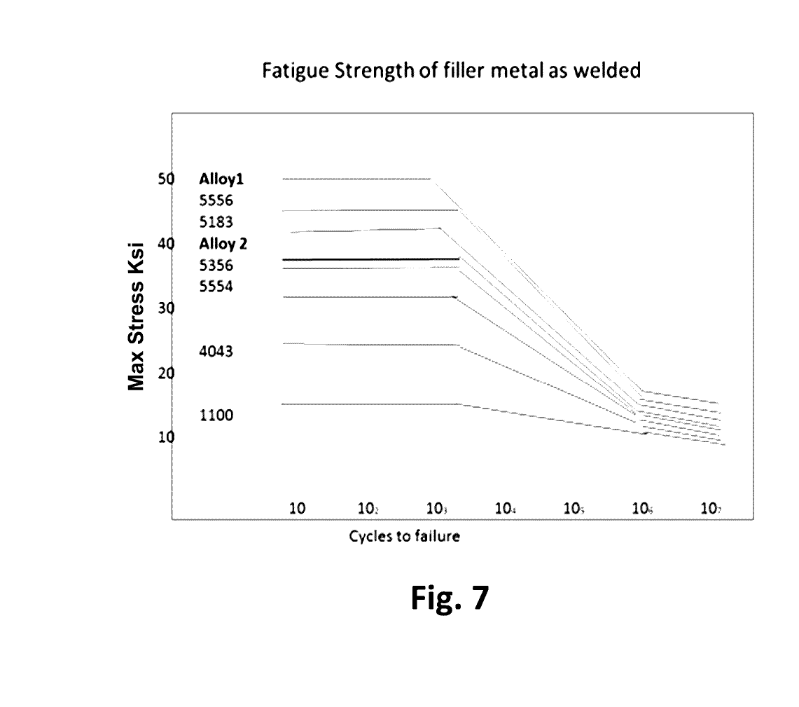

FIG. 4 is a table illustrating the typical as-welded shear and tensile strengths of various aluminum welding filler metal alloys along with the prophetic shear and tensile properties that the improved aluminum alloys have. In industry, the number of partially penetrated fillet type welds far exceeds fully penetrated butt type welds. Shear strength is the primary factor considered in designing weld strengths for all partially penetrated welds. For aluminum alloys, shear strength is calculated from the tensile strength and is 60 percent of the tensile strength. Fillet welds represent 70 percent of all structural welds. The improved aluminum alloy composition will provide significant increases in tensile, shear and fatigue strengths when compared to all of the other weld filler metal alloys in use today. Experience with aluminum-welded structures in service has shown that 90% of all failures are the result of cyclic loading and the failure of weld joints from fatigue. Because there are higher levels of discontinuities in weld joints than in the parent base material, there are higher levels of stress risers in the weld joints. The majority of welds are partially penetrated joints such as fillet welds. In these joints, the weld root in every weld is in fact a sharp notch. This notch acts as a stress riser during cyclic loading. In a fillet weld, the weld bead carries the full stress of cyclic loading. Consequently, the fatigue strength of the weld bead filler metal alloy is of prime importance. The fatigue crack initiation strength of an aluminum alloy is directly proportional to its tensile strength. The tensile properties of the improved aluminum alloy composition is higher than that of any currently available aluminum welding filler metal alloy and consequently the fatigue crack initiation properties are also higher. The prophetic fatigue strength targeted for the improved aluminum alloy composition is illustrated in FIG. 7.

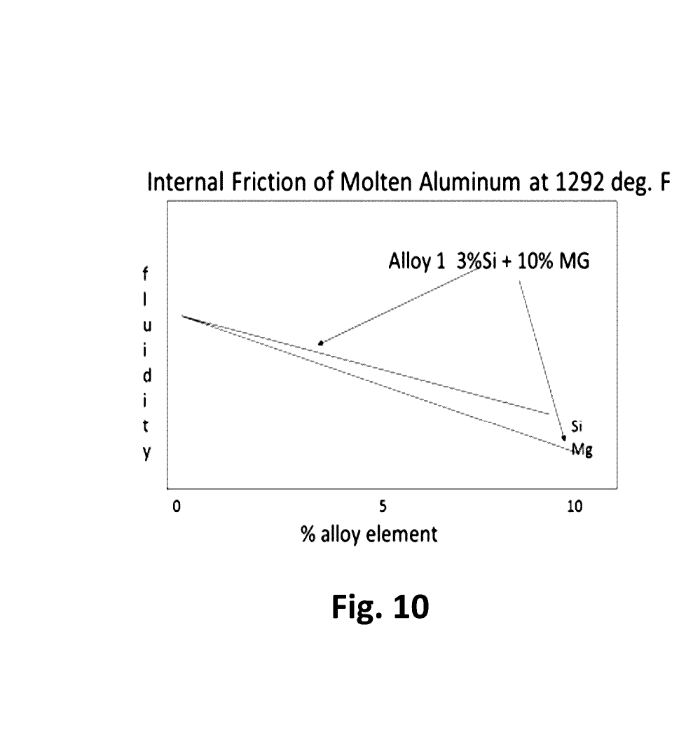

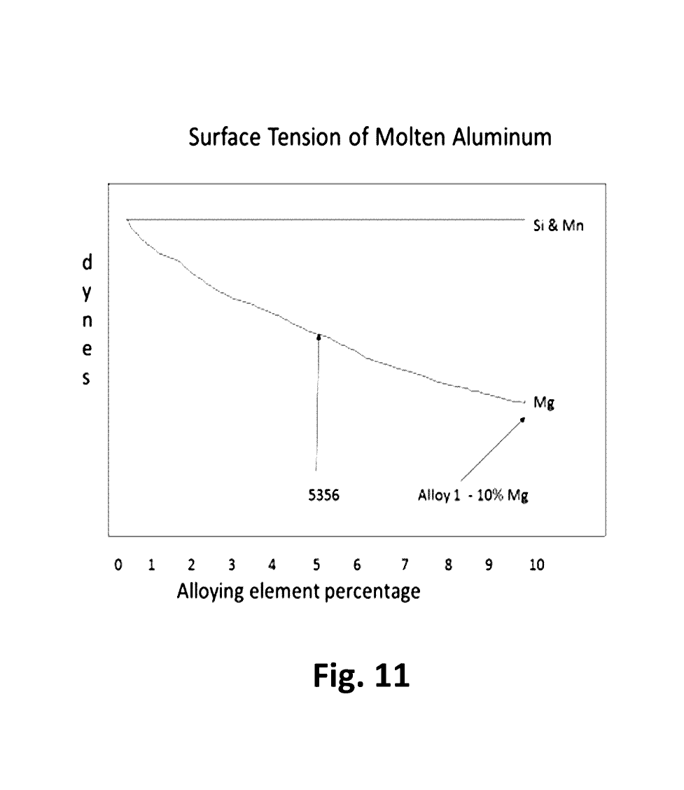

The improved aluminum alloy has also been designed to provide an increase in fluidity and a reduction in surface tension of the molten weld bead when used as a welding filler metal. The chart in FIG. 10 shows the effect of increasing alloy content on the fluidity of molten aluminum alloys. Fluidity of the molten weld bead affects the molten filler metal's wetting action during welding and the weld bead profile after solidification. The chart in FIG. 11 shows the effect of increasing alloy content on the surface tension of molten aluminum alloys. The surface tension on the molten weld bead also affects the weld bead profile during solidification. Higher fluidity and lower surface tension of a molten metal weld bead produces a lower and flatter weld bead profile after solidification. Welding standards control the allowable contour of weld beads. The improved aluminum alloy's chemical composition will provide improved wetting action and lower surface tension thereby improving the control over weld bead contour. A weld joint with reduced bead height and a lower angle of incidence of weld metal to base material will have superior fatigue life. The improved aluminum alloys will have improved fatigue strength characteristics not only from a material standpoint but also from the result of improved physical control over the weld bead contour. This is yet another objective of the improved aluminum alloy composition. The solidification cracking characteristics of aluminum weldments is sensitive to the chemistry of the filler metal alloy.

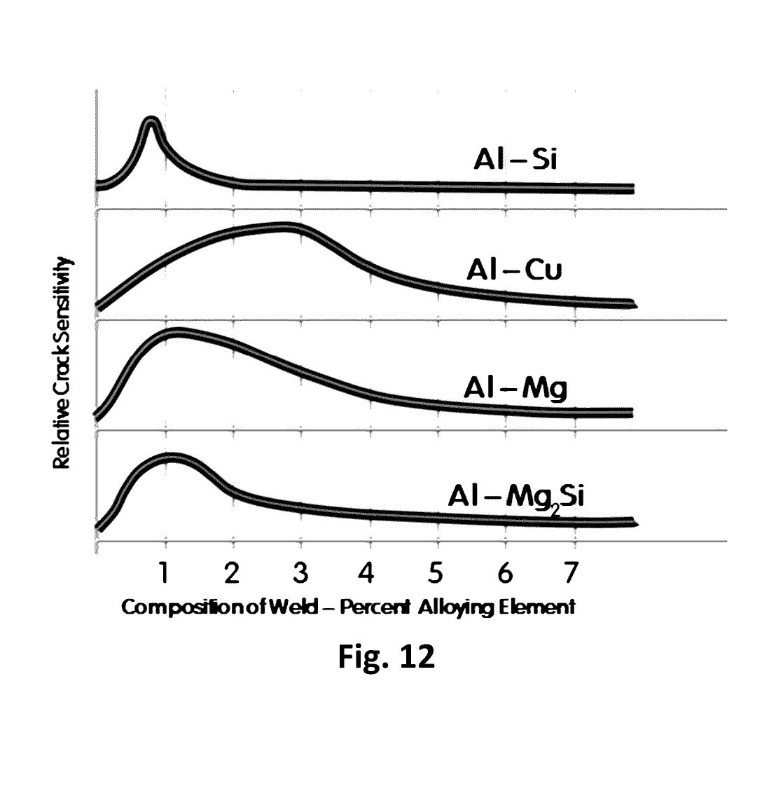

FIG. 12 shows the effects of Mg₂Si and free magnesium concentrations on the solidification cracking characteristics of a weldment. The improved aluminum alloy specifically controls the Mg₂Si concentration and the free magnesium concentration to control the cracking characteristics of the alloy during weld solidification.

The improved aluminum alloy composition has been designed to reduce hydrogen solubility in molten aluminum weld beads. In particular, magnesium atoms are about 25% larger than aluminum atoms, and expand the aluminum lattice structure allowing more hydrogen to be retained in solid solution and reduce the amount of hydrogen expelled during solidification. The reduction of hydrogen expelled during solidification reduces the amount of gas porosity in a weldment. Welding specifications limit the amount of allowable hydrogen gas porosity in welds in order to control mechanical properties. The improved aluminum alloys contain substantially greater amounts of controlling alloying elements than the weld filler metal alloys they are intended to replace. Consequently, they will have a lower propensity for hydrogen porosity contamination during welding. This is a specific design objective of this invention. The improved aluminum alloy composition has the ability to be fabricated into wire. In embodiments where the alloys are formed into wire, such wire (i.e., welding filler metal) may be produced on spools for use in GMA welding or it may be cut into straight lengths for GTA welding. These are the two most common forms of aluminum filler metals, but they are not limited to these forms. Typically, the linear wire or cut-to-length wire has a diameter of at least 0.010 inches and typically less than 0.30 inches in diameter. In preferred embodiments the wires have one or more diameters, such as 0.023 inches, 0.030 inches, 0.035 inches, 0.040 inches, 0.047 inches, 0.062 inches, 0.094 inches, 0.125 inches, 0.156 inches, 0.187 inches, and 0.250 inches. The improved aluminum alloys are specifically designed to be able to be drawn into all of the required wire sizes while the Mg₂Si constituent phase has been deliberately formed and coarsened through annealing. When excess magnesium is limited to approximately 5.2%, manganese is limited to approximately 0.40%, and the Mg₂Si phase is coarsened by annealing, the resulting alloy has acceptable mechanical cold-working properties.

While only certain features of the invention have been illustrated and described herein, many modifications and changes, including numerous alloy compositions will occur to those skilled in the art. It is therefore to be understood that the appended claims are intended to cover all such modifications and changes as fall within the true spirit of the invention. All documents cited herein, including journal articles or abstracts, published or corresponding U.S. or foreign patent applications, issued or foreign patents, or any other documents are each entirely incorporated by reference herein, including all data, tables, Figures, and text presented in the cited documents.

What is claimed is:

1. A metal alloy composition for use in a welding process, the metal alloy comprising:
aluminum in a weight percentage of between 70.0% and 98.9%;
silicon in a weight percentage of between 0.10% and 5.0%; and
magnesium in a weight percentage of between 1.0% and 15.0%.

2. The metal alloy composition of claim 1, wherein, by weight percentage,
the aluminum is between 75.0% and 96.8%,
the silicon is between 0.20% and 3.5%, and
the magnesium is between 3.0% and 11.0%.

3. The metal alloy composition of claim 2, further comprising:
manganese in a weight percentage of between 0.05% and 1.50%;
chromium in a weight percentage of between 0.05% and 0.35%;
titanium in a weight percentage of between 0.003% and 0.20%;
zirconium in a weight percentage of between 0.05% and 0.40%;
boron in a weight percentage of between 0.001% and 0.030%; and
phosphorous in a weight percentage of 0.50% maximum.

4. The metal alloy composition of claim 3, further comprising zinc in a weight percentage of 0.30% maximum.

5. The metal alloy composition of claim 3, further comprising beryllium in a weight percentage of 0.001% maximum.

6. The metal alloy composition of claim 5, wherein, by weight percentage, the beryllium is 0.0008% maximum.

7. The metal alloy composition of claim 3, further comprising iron in a weight percentage of 0.50% maximum.

8. The metal alloy composition of claim 3, wherein, by weight percentage, the chromium is between 0.05% and 0.20%.

9. The metal alloy composition of claim 3, wherein, by weight percentage, the titanium is between 0.003% and 0.10%.

10. The metal alloy composition of claim 3, wherein, by weight percentage, the boron is between 0.001% and 0.01%.

11. The metal alloy composition of claim 3, wherein, by weight percentage, the zirconium is between 0.05 and 0.40%.

12. The metal alloy composition of claim 1, wherein, by weight percentage,
the aluminum is between 75.0% and 93.9%,
the silicon is between 0.50% and 0.80%, and
the magnesium is between 5.60% and 6.30%.

13. The metal alloy composition of claim 12, further comprising:
manganese in a weight percentage of between 0.05% and 0.50%;
chromium in a weight percentage of between 0.05% and 0.20%;
titanium in a weight percentage of between 0.003% and 0.10%;
zirconium in a weight percentage of between 0.05% and 0.15%;
boron in a weight percentage of between 0.001% and 0.01%; and
phosphorous in a weight percentage of 0.05% maximum.

14. The metal alloy composition of claim 12, wherein the silicon and magnesium is in the form of magnesium silicide (Mg₂Si) in a weight percentage of approximately 1.70% and free magnesium in a weight percentage of approximately 5.0%.

15. The metal alloy composition of claim 1, further comprising manganese in a weight percentage of between 0.50% and 1.0%, and wherein, by weight percentage, the aluminum is between 75.0% and 95.9%, the silicon is between 0.30% and 0.50%, and the magnesium is between 3.30% and 3.80%.

16. The metal alloy composition of claim 15, further comprising:
chromium in a weight percentage of between 0.05% and 0.20%;
titanium in a weight percentage of between 0.003% and 0.10%;
zirconium in a weight percentage of between 0.05% and 0.20%;
boron in a weight percentage of between 0.001% and 0.01%; and
phosphorous in a weight percentage of 0.05% maximum.

17. The metal alloy composition of claim 15, wherein the silicon and magnesium is in the form of magnesium silicide (Mg₂Si) in a weight percentage of approximately 1.1% and free magnesium in a weight percentage of approximately 2.9%.

18. The metal alloy composition of claim 1, wherein, by weight percentage,
the aluminum is between 75.0% and 88.5%,
the silicon is between 2.50% and 3.10%, and
the magnesium is between 9.0% and 10.4%.

19. The metal alloy composition of claim 18, further comprising:
manganese in a weight percentage of between 0.20% and 0.50%;
chromium in a weight percentage of between 0.05% and 0.20%;
titanium in a weight percentage of between 0.003% and 0.10%;
zirconium in a weight percentage of between 0.05% and 0.20%;
boron in a weight percentage of between 0.001% and 0.01%; and
phosphorous in a weight percentage of 0.05% maximum.

20. The metal alloy composition of claim 18, wherein the silicon and magnesium is in the form of magnesium silicide (Mg₂Si) in a weight percentage of approximately 8% and free magnesium in a weight percentage of approximately 5.0%.

21. The metal alloy composition of claim 1, wherein, by weight percentage,
the aluminum is between 75.0% and 93.3%,
the silicon is between 2.50% and 3.10%, and
the magnesium is between 4.2% and 5.2%.

22. The metal alloy composition of claim 21, further comprising:
manganese in a weight percentage of between 0.40% and 0.70%;
chromium in a weight percentage of between 0.05% and 0.20%;
titanium in a weight percentage of between 0.003% and 0.10%;
zirconium in a weight percentage of between 0.05% and 0.20%;
boron in a weight percentage of between 0.001% and 0.01%; and
phosphorous in a weight percentage of 0.05% maximum.

23. The metal alloy composition of claim 21, wherein the silicon and magnesium is in the form of magnesium silicide (Mg₂Si) in a weight percentage of approximately 8.0%.

24. The metal alloy composition of claim 1, wherein the metal alloy is a 5xxx or 6xxx series aluminum welding filler metal.

25. The metal alloy composition of claim 1, wherein the metal alloy composition is configured to, through a welding process, create a super-heated saturated liquid composition in a liquid saturated state and, when quenched to a solid state from the liquid saturated state via a base metal in a weld joint, excess magnesium is retained in solid solution and magnesium silicide (Mg₂Si) is retained in solid solution, precipitates, and dispersoids, wherein the solid solution results in improved physical and mechanical properties of the weld joint.

26. The metal alloy composition of claim 1, wherein the metal alloy composition is a 5xxx or 6xxx series aluminum welding filler metal that yields improved mechanical tensile and shear properties, the improved mechanical tensile and shear properties being up to 57 ksi and shear properties being up to 33 ksi.

27. The metal alloy composition of claim 1, wherein the metal alloy composition is a 5xxx or 6xxx series aluminum welding filler metal that yields improved fatigue initiation strength, the improved fatigue initiation strength being up to 57 ksi initiation strength and up to a fatigue limit of 26 ksi at 500 million cycles.

28. The metal alloy composition of claim 1, wherein the metal alloy composition has a lower conductivity to increase a burn off rate of the filler wire in the electrical arc, thereby increasing welding deposition rates and increasing welding productivity, wherein the conductivity is down to 25 International Annealed Copper Standard (IACS).

29. The metal alloy composition of claim 1, wherein the metal alloy composition produces lower internal friction, higher fluidity up to an internal friction of 1.0 centipoise at 1292 deg. F, and reduced surface tension down to 570 dynes per cm at 1292 deg. F in the molten metal state to improve weld bead contour and joint root wetting.

30. The metal alloy composition of claim 1, wherein the metal alloy composition produces lower out of solution hydrogen gas porosity in weldments than 5xxx alloys such as 5356 or 5183, where the porosity producing hydrogen content is measured in ml/100 g when weldments are made with similar arc hydrogen contents.

31. The metal alloy composition of claim 1, wherein the metal alloy composition has solid solute or constituents that are controlled such that there are no significant differences in electro negativities, wherein the potential volts of constituents and aluminum are controlled within ranges such that the weld metal has excellent intergranular corrosion, including stress corrosion, performance in salt-water to provide a high strength and high corrosion resistance combination of properties suitable for salt-water exposure, wherein pure aluminum (99.95% Al) has potential volts of −0.85, Al+1% Mg₂Si has potential volts of −0.83, Al+5% mg had potential volts of −0.88 and Mg₂Si constituents have potential volts of −0.82.

32. The metal alloy composition of claim 1, wherein the metal alloy composition comprises magnesium silicide (Mg₂Si) and free magnesium (free Mg), wherein Mg₂Si and free Mg concentrations are controlled to provide a non-solidification crack sensitive filler metal, wherein the low solidification crack sensitive chemistry allows for a Mg₂Si and free Mg alloy (6xxx) to be used for filler metal commercial applications.

33. The metal alloy composition of claim 1, wherein the metal alloy composition is configured to be plastically deformed into a welding wire of one or more welding wire sizes by controlling the amount of (Mg₂Si) in solution, whereby a specifically controlled amount of Mg is combined with Si in the form of magnesium silicide (Mg₂Si).

34. The metal alloy composition of claim 33, wherein metal alloy composition is cold worked by rolling and drawing the alloy composition, including specifically designed thermal treatments, into a welding wire having a fine diameter.

35. A method of manufacturing a filler metal for welding aluminum materials, the method comprising: plastically deforming a metal alloy to form the filler metal, the metal alloy comprising aluminum in a weight percentage of between 70.0% and 98.9%, silicon in a weight percentage of between 0.10% and 5.0%, and magnesium in a weight percentage of between 1.0% and 15.0%.

36. The method of claim 35, wherein the plastically deforming includes extruding or drawing.

37. A weldment, comprising:
a first base metal; and
a second base metal welded to the first base metal at a weld joint, wherein the weld joint is formed via a welding process using a filler metal comprising aluminum in a weight percentage of between 70.0% and 98.9%, silicon in a weight percentage of between 0.10% and 5.0%, and magnesium in a weight percentage of between 1.0% and 15.0%.
